(19) United States
(12) Patent Application Publication
(10) Pub. No.: US 2004/0121907 A1
(43) Pub. Date: Jun. 24, 2004

(54) Catalyst carrier

(76) Inventor: Wen Shing Chang, Taipei (TW)

Correspondence Address: Wen Shing Chang, 235 Chung - Ho, Box 8-24, Taipei, TW

(21) Appl. No.: 10/321,963

(22) Filed: Dec. 19, 2002

(51) Int. Cl. B01J 23/02

(52) U.S. Cl. 502/439

(57) ABSTRACT

A catalyst carrier is a piece carrier, and a plurality of waveform groove sections is formed on the piece carrier. In the piece carrier, the groove sections includes a plurality of upward grooves and a plurality of downward grooves. The upward grooves and downward grooves are arranged alternatively with a part of an opening of each upward groove being overlapped with a part of an opening of a respective downward grooves, so as to form a plurality of outward flowing channels and a plurality of inward flowing channels which are communicated with outer environment. Catalyst is coated upon the surfaces of the upward grooves and downward grooves. Thereby, the total area for coating catalyst is increased and the air is turbulent as flowing through the piece carrier.

### FIELD OF THE INVENTION

The present invention relates to catalyst carriers, and particularly to a catalyst carrier with is especially suitable to a small engine with an engine capacity of less than 100 C. C. By the present invention, the exhaust gas has a sufficient time to react with the catalyst so as to increase the conversion efficiency. Thereby, the present invention can be installed in a small muffler for a small engine to improve the efficiency of removing purifying exhaust gas.

### BACKGROUND OF THE INVENTION

Generally, a catalyst converter is installed to the exhaust pipe or a muffler of an engine for preventing harmful material from flowing out to the environment. Thus, the exhausting air is cleaned before being exhausted.

Moreover, many of general used machines, such as grass cutter or electric saws, has an engine capacity of less than 100 C. C., thereby, being called as small engines. In general, these small engines are not installed with exhausting pipes. One mufflers are installed at one ends of the engines while the mufflers are also small. These mufflers serve to reduce the noises of the engines and small catalyst converters are installed in the small mufflers for cleaning exhaust gas. Since the compressing ratio of the engine is small and thus incomplete combustion easily occurs so that the concentration in the harmful material is high. However, the prior art used vortex (cell form) carriers or net form ceramic carrier only has finite area for coating the catalyst, but this area coating the catalyst is insufficient.

Thereby, the prior art can not completely resolve the problem in the environment protection and thus it is necessary to be improved.

### SUMMARY OF THE INVENTION

Accordingly, the primary object of the present invention is to provide a catalyst carrier which is a piece carrier, a plurality of waveform groove sections being formed on the piece carrier;

In the piece carrier, the groove sections include a plurality of upward grooves and a plurality of downward grooves. The upward grooves and downward grooves are arranged alternatively with a part of each upward groove being engaged with a part of a respective downward grooves, so as to form a plurality of outward flowing channels and a plurality of inward flowing channels which are communicated with outer environment. Catalyst is coated upon the surfaces of the upward grooves and downward grooves;

Thereby, the total area for coating catalyst is increased and the exhaust gas is turbulent as flowing through the piece carrier.

The present invention is especially suitable for small engines with an engine capacity of less than 100 C. C.

The various objects and advantages of the present invention will be more readily understood from the following detailed description when read in conjunction with the appended drawing.

### BRIEF DESCRIPTION OF THE DRAWINGS

FIG. 1 is a partial cross sectional view showing that the carrier of the present invention is assembled to a muffler of a small engine.

FIG. 2 is a cross sectional view along line 2-2 of FIG. 1.

FIG. 3 is a partial perspective view showing the section 3 of FIG. 1.

FIG. 4 is a partial schematic view showing the section 3 of FIG. 1.

### BRIEF DESCRIPTION OF THE PREFERRED EMBODIMENT

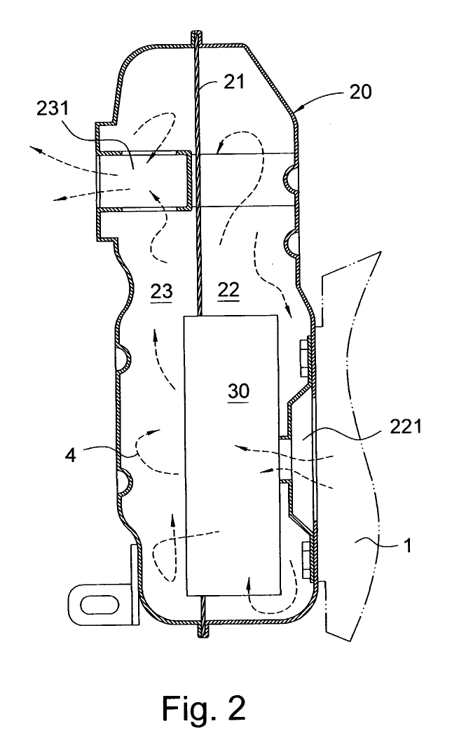

Referring to FIG. 2, a partial schematic view of the catalyst carrier of the present invention is illustrated. The catalyst 5 assembled to a small muffler 20 includes a muffler 20 assembled to a small engine exhausting gas end 1 and a piece carrier 30.

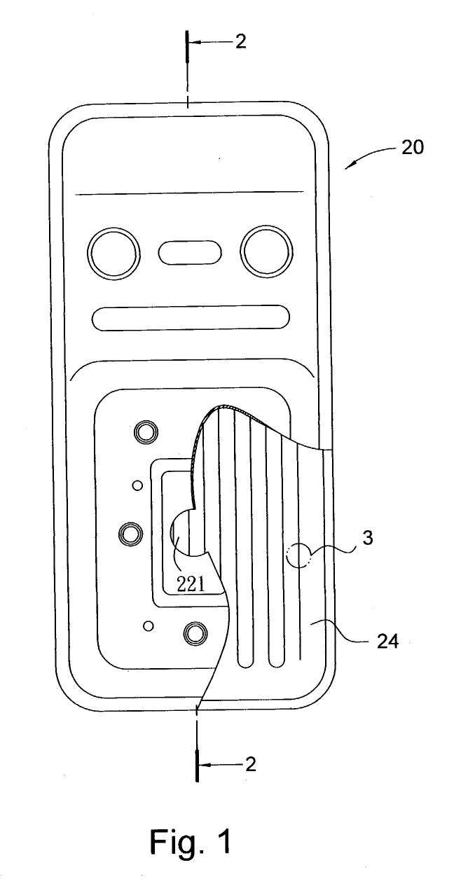

The muffler 20 has a cavity 24 (referring to FIG. 1). The cavity 24 has a spacer 21 which space the cavity 24 into an air inlet chamber 22 and an air exhausting chamber 23 (referring to FIG. 2). The air inlet chamber 22 has an air inlet channel 221. The air exhausting chamber 23 has an exhausting gas channel 231. An inlet of the air inlet channel 221 is connected to the small engine exhausting gas end 1. An outlet of the exhausting gas channel 231 is directly communicated with the outer environment.

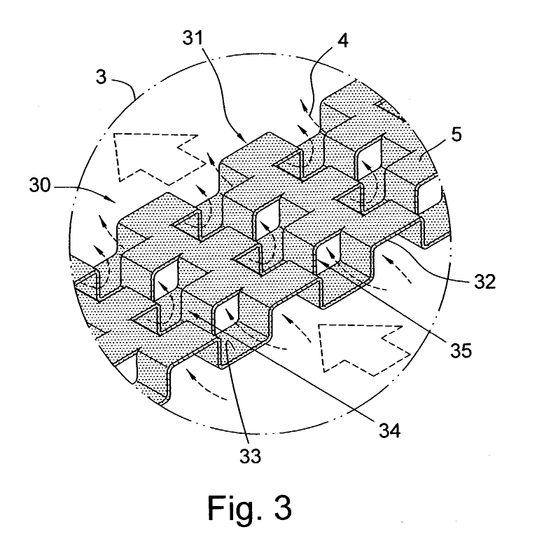

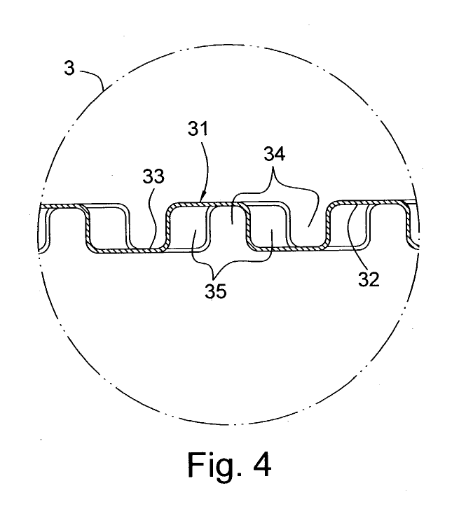

The piece carrier 30 is bent and folded in a hole of the spacer 21 (referring to FIG. 2). The piece carrier 30 is tightly adhered to the inner end of the exhausting gas channel 231. The piece carrier 30 is formed with a plurality of alternatively arranged wavelike groove sections 31 (referring to FIG. 3). The groove section 31 can be classified as upward grooves 33 and downward grooves 32. The upward grooves 33 and downward grooves 32 are formed with outward flowing channels 34 and inward flowing channels 35 (referring to FIGS. 3 and 4).

The piece carrier 30 has a larger surface area. The surfaces of the upward grooves 32 and downward grooves 33 are coated with catalyst 5 (referring to FIG. 3) so as to increase the amount of the catalyst 5 covering upon the piece carrier 30.

In the embodiment of the present invention, waste gas 4 out of the small engine exhausting gas end 1 may be guided into the small muffler 20 through the air inlet channel 221 (referring to FIG. 2) and the air flows through the outward flowing channel 34 and inward flowing channel 35 of the piece carrier 30 (referring to FIGS. 3 and 4) so that the waste gas 4 has a sufficient time to react with the catalyst 5 to increase the efficiency of removing the harmful material in the waste gas 4. Thereby, the present invention can be installed in a small muffler 20 for improving the efficiency of removing the harmful material. The present invention is especially suitable for small engines with an engine capacity of less than 100 C. C.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A catalyst carrier; the catalyst carrier being a piece carrier, a plurality of groove sections being formed on the piece carrier;
the groove sections being formed by a plurality of upward grooves with an opening of each upward groove facing upwards and a plurality of downward grooves with an opening of each downward groove facing downwards; the upward grooves and downward grooves are arranged alternatively with a part of the opening of each upward groove being overlapped with a part of the opening of a respective downward groove, so as to form a plurality of outward flowing channels and a plurality of inward flowing channels which are communicated with outer environment; catalyst being coated upon the surfaces of the upward grooves and downward grooves;
by above mentioned piece carrier, the total area for coating catalyst is increased and the air is turbulent as flowing through the piece carrier.

2. The catalyst carrier as claimed in claim 1, wherein the piece carriers are assembled in a muffler at an exhausting gas end of an engine.
